(19) United States
(12) Patent Application Publication
(10) Pub. No.: US 2008/0247692 A1
(43) Pub. Date: Oct. 9, 2008

(54) Extrudable Polymer Bearing Insert

(75) Inventor: Jonathan R. Schroeder, Roscoe, IL (US)

Correspondence Address: REINHART BOERNER VAN DEUREN P.C., 2215 PERRYGREEN WAY, ROCKFORD, IL, 61107, US

(73) Assignee: Pacific Bearing Company, Rockford, IL (US)

(21) Appl. No.: 11/696,586

(22) Filed: Apr. 4, 2007

(51) Int. Cl. F16C 33/02

(52) U.S. Cl. 384/296; 384/297

(57) ABSTRACT

A bearing insert, apparatus, and method use a bearing insert of polymer material, defining a longitudinal axis along which the bearing insert may be net-shape-formed by extrusion. Arrangements and methods are also provided for retaining the extrudable bearing insert within either open or closed bearing housings.

### FIELD OF THE INVENTION

This invention pertains to sliding bearings for shafts and the like, and more particularly to sliding bearings incorporating snap-in polymer inserts.

### BACKGROUND OF THE INVENTION

It is known to utilize a sliding bearing apparatus, including a bearing housing having a cylindrical opening extending longitudinally therethrough, in combination with a polymer bearing insert inserted into the cylindrical opening in the bearing housing, in conjunction with a shaft extending longitudinally through the bearing insert. Sliding bearing apparatuses of this type are disclosed in U.S. Pat. No. 6,113,275, to Blase, titled “Plain Bearing.”

Prior bearing apparatuses, such as the ones disclosed by Blase, include a bearing body having a slit extending along the entire length of its axis, and at least deformable zone, likewise extending along the entire length of the axis, to thereby allow the slit to be open so that the bearing body can be fitted to the shaft and removed from the shaft in a radial direction. Blase discloses bearing insert configurations having a plurality of projections which lock into an annular groove in a bearing housing, to secure the insert against axial movement within the housing, in combination with another projection, which engages a through-hole in the housing to secure the bearing body against radial movement within the housing.

Experience has shown that prior bearing arrangements, and polymer bearing inserts used therein, are undesirably complex to manufacture and install. For example, the bearing inserts disclosed in Blase are more difficult than is desirable to manufacture, due to the necessity for providing multiple protrusions which act individually for locking the insert against axial and radial movement respectively within the housing. Installation of the insert of Blase is also complicated by the necessity for using a two-step process, in which the protrusions which prevent axial movement within the housing are first engaged, and then, sequentially, the protrusion precluding radial motion is engaged with the housing.

The precise requirements for shape, and location of features such as the protrusions of Blase, have significantly limited the options available for molding or otherwise fabricating prior polymer sliding bearing inserts. Also, in the past, it has typically been necessary for manufactures and service organizations to carry a large inventory of differently shaped and sized bearing inserts which could typically be used only in a single application, such as a completely closed, or an open bearing arrangement.

In a commonly assigned patent application, filed concurrently herewith, under Attorney Docket No. 505948, the Applicant disclosed bearing inserts, apparatuses and methods providing considerable improvement over prior approaches, such as those disclosed by Blase, through use of a bearing insert having a single outwardly extending protrusion configured for retaining the bearing insert within a cylindrical opening in a bearing housing against movement in both the radial and axial directions simultaneously. Although the Applicant's co-pending patent application (Attorney Docket No. 505948) provides significant improvement over prior art approaches, such as the one disclosed in Blase, and has been shown to work well in a number of bearing applications, further improvement is desirable.

What is needed, therefore, is an improved sliding bearing apparatus and/or polymer bearing insert, and improved methods for constructing and using sliding bearing apparatuses or polymer bearing inserts of the type typically used therein.

### BRIEF SUMMARY OF THE INVENTION

The invention provides an improved bearing insert, apparatus, and method, through use of a bearing insert of polymer material defining a longitudinal axis along which the bearing insert may be net-shape-formed by extrusion. The invention further provides for retaining such an extrudable bearing insert within either open or closed bearing housings.

The term “extrudable,” as used with regard to the invention, is intended to mean that an insert, according to the invention, must be configured in such a manner that the insert can be net-shape-formed by extrusion along a longitudinal axis of the insert. It is contemplated, however, that, in some forms of the invention, an extrudable insert, according to the invention, may be formed through the use of some other process such as molding.

Through use of the extrudable bearing insert of the invention, excess complexity, cost, and difficulty of use experienced in prior bearing apparatuses, having bearing inserts including outwardly extending protrusions which could not be net-shape-formed by extrusion, are eliminated or significantly reduced.

In one form of the invention, an extrudable polymer bearing insert is provided, for a sliding bearing. The extrudable bearing insert is adapted for insertion into a substantially cylindrical, longitudinally oriented, opening in a bearing housing, for use with a shaft extending longitudinally through the cylindrical opening in the bearing housing, with the shaft having a radius, an outer diameter, and a corresponding circumference thereof. The bearing insert includes a body of polymer material defining a longitudinal axis of the insert along which the insert may be net-shape-formed by extrusion. The body also defines first and second spaced longitudinal edges of the insert, extending substantially parallel to the longitudinal axis of the insert. The body further defines a plurality of longitudinally extending bearing segments, joined to one another by flexible webs.

The bearing segments each define inner and outer substantially longitudinally extending surfaces thereof. The inner surface of each of the bearing segments has a longitudinally extending radiused recess therein, with the radius of the radiused recesses substantially matching the radius of the shaft, and formed for bearing against a portion of the circumference of the shaft. The outer surface of each of the bearing segments is formed in such a manner that, when the insert is disposed within the cylindrical opening in the bearing housing, the inner surfaces of the bearing segments, in combination with one another, substantially define a circumferentially interrupted bore having an internal radius substantially matching the radius of the shaft, and such that the longitudinal edges of the insert form a longitudinally extending opening therebetween.

In some forms of the invention, each of the bearing segments defines side walls thereof, with one of the side walls of each of a first and a second one of the bearing segments defining the first and second longitudinally extending edges of the insert. The bearing insert is further configured to be longitudinally trimmable along a side edge of another one or more bearing segments for forming an insert for an open bearing.

A bearing insert, according to the invention, may be configured to assume a substantially cylindrical form, in a free-standing state, when not inserted into the cylindrical opening of the bearing housing. Alternatively, a bearing insert, according to the invention, may be configured to assume a substantially non-cylindrical form in a free-standing state, when not inserted into the cylindrical opening in the bearing housing. In other forms of the invention, a bearing insert, according to the invention, may be configured to assume a substantially flat, planar form in a free-standing state, when not inserted into the cylindrical opening in the bearing housing.

Where the invention is practiced with an open bearing in which the bearing housing defines a longitudinally extending slot therein, opening outward from the cylindrical opening in the housing and defining first and second longitudinally extending edges of the slot in the housing, a bearing insert, according to the invention, may further include longitudinally extending locating flanges for securing the bearing insert within the housing of the open bearing. The bearing insert may include longitudinally extending first and second locating flanges, having backsides thereof extending outward from the first and second longitudinally extending edges of the insert to a point beyond the outer surface of the bearing segments, with the backsides of the locating flanges being adapted for substantially faying contact with the first and second longitudinally extending edges of the slot in the bearing housing of the open bearing.

In forms of the invention including locating flanges, for use with an open bearing arrangement, except for the locating flanges, the bearing insert may take a variety of alternative forms, in a free-standing state, including a substantially cylindrical form, a substantially non-cylindrical form, and a substantially flat planar form, when the bearing insert is not inserted into the cylindrical opening in the bearing housing.

In one form of a method, according to the invention, an extrudable bearing insert, in accordance with the invention, is formed by extruding the bearing insert along the longitudinal axis of the bearing insert. The method may further include extruding a body having an initial length greater than a desired axial length of the bearing insert, and cutting the body to the desired axial length of the bearing insert. In some forms of the invention, a body having a length several times greater than the desired axial length of the bearing insert may be formed by extrusion, molding, or any other appropriate process, and the method may further include cutting the bearing insert to length from the elongated body. In this manner, a single elongated body of polymer material may be utilized for forming a number of individual bearing inserts, with the individual bearing inserts having the same or differing axial lengths from one another. In this manner, inventory requirements may be reduced by producing standardized elongated bodies of material, and cutting bearing inserts of a desired length from the blanks to fulfill requirements for bearing inserts of various lengths.

In some forms of the invention, each of the bearing segments of the extrudable bearing insert defines sidewalls thereof, with one of the sidewalls of each of a first and a second one of the bearing segments defining the first and second longitudinally extending edges of the insert. The bearing insert is further configured to be longitudinally trimmable along a side edge of another one or more bearing segments for forming an insert of an open bearing.

A method, according to the invention, may include longitudinally trimming the bearing insert along a side edge of the another one of the another one or more bearing inserts. In this manner, an extrudable bearing insert, according to the invention, which was initially configured for use in a closed bearing, may be converted for use in an open bearing. This capability to convert a bearing insert initially formed for use in a closed bearing into an open bearing provides significant advantages in reduction of inventory, through practice of the invention.

The invention may also take the form of a bearing apparatus, including a bearing housing having a cylindrical opening extending substantially longitudinally therethrough, and an extrudable bearing insert adapted for insertion into the substantially cylindrically oriented opening in the bearing housing, for use with a shaft extending longitudinally through the cylindrical opening in the bearing housing, where the shaft has a radius, an outer diameter, and a corresponding circumference thereof. The bearing insert includes a unitary body of polymer material, defining a longitudinal axis of the insert along which the insert may be net-shape-formed by extrusion. The body also defines first and second spaced longitudinal ends of the insert, extending substantially parallel to the longitudinal axis of the insert. The body further defines a plurality of longitudinally extending bearing segments joined to one another by flexible webs.

The bearing segments each define inner and outer substantially longitudinally extending surfaces thereof. The inner surface of each of the bearing segments has a longitudinally extending radiused recess therein, with the radius of the radiused recess substantially matching the radius of the shaft, and configured for bearing against the portion of the circumference of the shaft. The outer surface of each of the bearing segments is formed in such a manner that, when the insert is disposed in the cylindrical opening in the bearing housing, the inner surfaces of the bearing segments, in combination with one another, substantially define a circumferentially interrupted bore having an internal radius substantially matching the radius of the shaft, and such that the longitudinal edges of the insert form a longitudinally extending opening therebetween.

In some forms of a bearing apparatus, according to the invention, an adhesive is disposed between the bearing insert and the housing, for attaching the bearing insert to the housing, to thereby retain the bearing insert within the cylindrical opening in the bearing housing.

In other forms of a bearing apparatus, according to the invention, the bearing insert further defines a longitudinal length thereof extending between first and second axial ends of the bearing insert, and the bearing housing has a longitudinal length, extending between first and second axial ends of the bearing housing. The bearing housing further includes at least one insert retaining feature extending substantially radially into the cylindrical opening in the bearing housing for engaging one of the axial ends of the bearing insert, to thereby preclude axial movement of the insert with respect to the bearing housing when the bearing insert is disposed within the cylindrical bore. In some forms of the invention, the insert retaining feature may include an annular flange disposed within the cylindrical opening in the bearing housing adjacent one of the axial ends of the bearing housing. The bearing housing may further include annular flanges disposed within the cylindrical opening in the bearing housing adjacent both axial ends of the bearing housing.

Where the bearing apparatus is an open bearing, the bearing housing may further define a longitudinally extending slot therein opening outward from the cylindrical opening in the housing, and defining first and second longitudinally extending edges of the slot in the housing. The bearing insert may further include longitudinally extending first and second locating flanges, having backsides thereof extending outward from the first and second longitudinally extending edges of the insert, to a point beyond the outer surface of the bearing segments, with the backsides of the locating flanges being adapted for substantially faying contact with the first and second longitudinally extending edges of the slot in the bearing housing. The first and second longitudinally extending edges of the housing may each include one or more depressions therein, and the locating flanges may include corresponding deformations therein configured for engaging the depressions on the longitudinally extending edges of the slot in the bearing housing. In a method, according to the invention, the deformations in the locating flanges in the bearing insert may be formed by application of ultrasonic energy to the locating flange at a position opposite from the corresponding depression in the edges of the slot in the bearing housing, to thereby cause a portion of the locating flange to deform into its corresponding depression in the longitudinally extending flange of the housing.

In some forms of the invention, an extrudable bearing insert for an open bearing does not include locating flanges. In such forms of the invention, a bearing housing, according to the invention, may further include one or more inwardly extending retaining elements, disposed adjacent the first and second edges of the longitudinally extending slot in the bearing housing, and adapted for operatively engaging the first and second longitudinal edges of the bearing insert, to thereby preclude radial movement of the insert within the cylindrical opening in the housing. These inwardly extending retaining elements may include longitudinally extending flanges. In some forms of the invention, for open bearings, the bearing housing includes one or more inwardly extending annular flanges at opposite axial ends of the cylindrical bore, in combination with longitudinally extending flanges adjacent the edges of the longitudinally extending slot in the housing, to thereby preclude both axial and radial movement of the extrudable bearing insert with respect to the bearing housing.

In some forms of the invention, a bearing housing, according to the invention, may include at least one insert retaining feature extending substantially radially into the cylindrical opening in the bearing housing for engaging the bearing insert, to thereby preclude movement of the insert with respect to the bearing housing when the bearing insert is disposed within the cylindrical bore. The bearing insert may further include a retaining recess therein cooperatively configured for operatively engaging the insert retaining feature extending form the housing. In embodiments of the invention where the extrudable bearing insert is otherwise net-shape-formed by extrusion, a secondary operation is performed on the extruded bearing insert to form the retaining recess therein. In embodiments of the invention where the extrudable bearing insert is molded, for example, it is contemplated that the retaining recess may be molded into the insert.

The invention may also take the form of a method for constructing, utilizing or replacing a bearing insert or bearing housing, according to the invention, or a method for constructing, utilizing or repairing a bearing insert, a bearing housing, or a bearing apparatus, according to the invention.

Other aspects, objectives and advantages of the invention will be apparent from the following detailed description and accompanying drawings of exemplary embodiment of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 and 2 are a perspective illustration and an end view, respectively, of a first exemplary embodiment of a sliding bearing apparatus, according to the invention, including an extrudable bearing insert, according to the invention.

FIGS. 3 and 4 are enlarged views of the extrudable bearing insert of the exemplary embodiment of FIGS. 1 and 2, illustrating various features and construction of an extrudable bearing insert, according to the invention.

FIG. 5 is an exploded perspective view of the first exemplary embodiment of the bearing apparatus, according to the invention, shown in FIG. 1.

FIGS. 6-10 are a series of orthographic and perspective illustrations showing an extrudable bearing insert, according to the invention, configured in such a manner that the bearing insert assumes a substantially flat, planar shape when in a free-standing state.

FIGS. 11-13 are a perspective assembled view, and end assembled view, and a perspective exploded view, respectively, of a second exemplary embodiment of a closed bearing apparatus, according to the invention, having annular flanges at opposite ends of a cylindrical opening in the bearing housing for aiding retention of an extrudable bearing insert, according to the invention, within the housing of the bearing apparatus.

FIGS. 14-16 are a perspective assembled view, and assembled end view, and a perspective exploded view, respectively, of a third exemplary embodiment of the invention, in the form of an open bearing apparatus having an extrudable bearing insert, according to the invention.

FIGS. 17 and 18 are perspective illustrations of a fourth exemplary embodiment of a bearing apparatus, according to the invention, in the form of an open bearing arrangement in which the bearing housing includes a pair of deformable, longitudinally extending ribs for providing retention of an extrudable insert within the bearing housing.

FIGS. 19 and 20 are assembled and exploded perspective views, respectively, of a fifth exemplary embodiment of the invention, in the form of an open bearing arrangement, in which an extrudable bearing insert includes a pair of longitudinally extending locating flanges configured for faying contact with longitudinally extending edges of the bearing housing.

FIG. 21 is an end view of the fifth exemplary embodiment of the invention shown in FIG. 19.

FIGS. 22-24 are cross-sectional illustrations of the fifth exemplary embodiment of the invention, shown in FIGS. 19-21, illustrating one way of anchoring the locating flanges of the extrudable bearing insert to the housing, by deforming a portion of the locating flanges into recesses in the longitudinal edges of the housing, utilizing application of ultrasonic energy from a transducer or other appropriate means.

FIG. 26 is a cross-sectional view of a sixth exemplary embodiment of the invention in which the housing includes a bearing insert retention element extending into the cylindrical opening in the housing for engagement with a corresponding recess in an extrudable bearing insert in such a manner that the bearing insert is retained within the housing against both axial and radial movement with respect to the housing.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

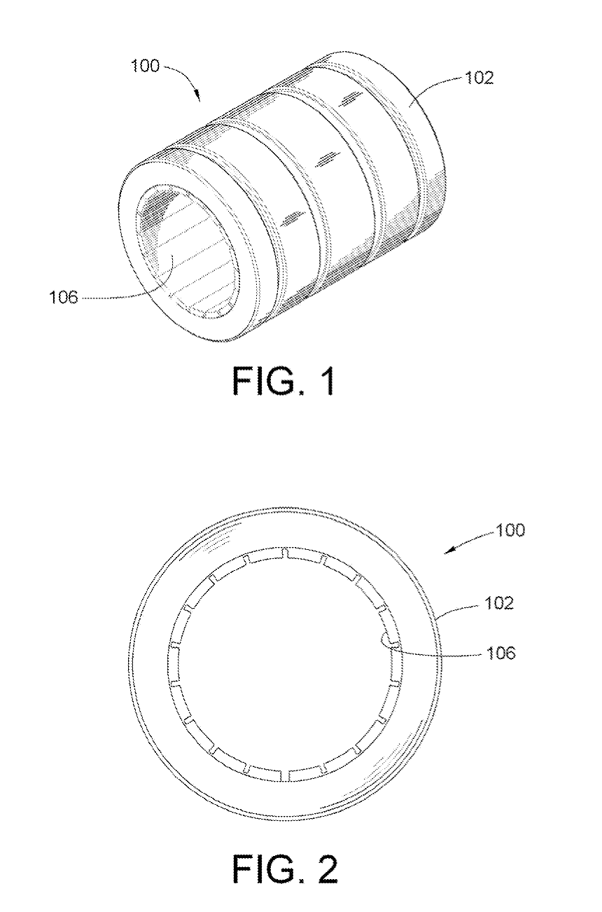

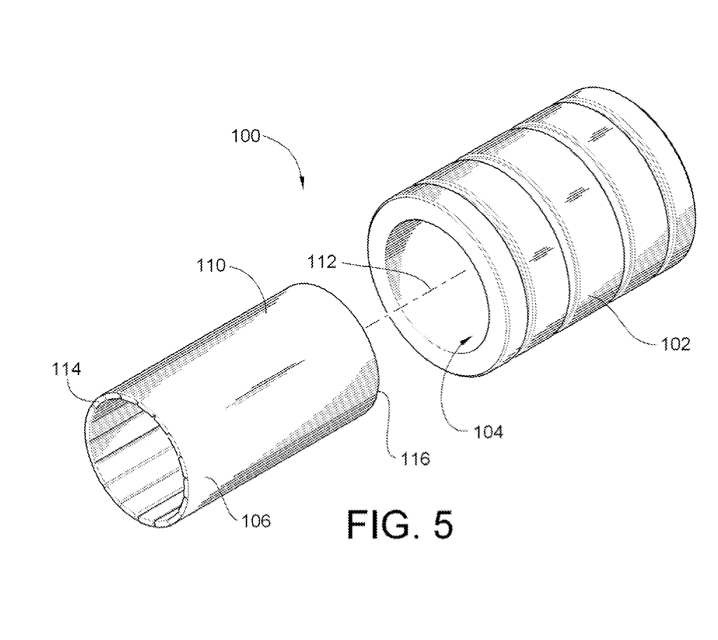

FIGS. 1-5, show a first exemplary embodiment of a sliding bearing apparatus 100 including a bearing housing 102, having a cylindrical opening 104 extending substantially longitudinally therethrough, and a bearing insert 106 adapted for insertion into the longitudinal bore 104 in the bearing housing 102.

The bearing insert 106 is adapted for insertion into the substantially cylindrical longitudinally oriented opening 104 in the bearing housing 102, and is configured for use with a shaft (not shown) extending longitudinally through the bearing insert 106 and the cylindrical opening 104 in the bearing housing 102, with the shaft having a radius, an outer diameter, and a corresponding circumference thereof, with the radius outer diameter and circumference of the shaft not being shown in the drawings for the sake of clarity of illustration.

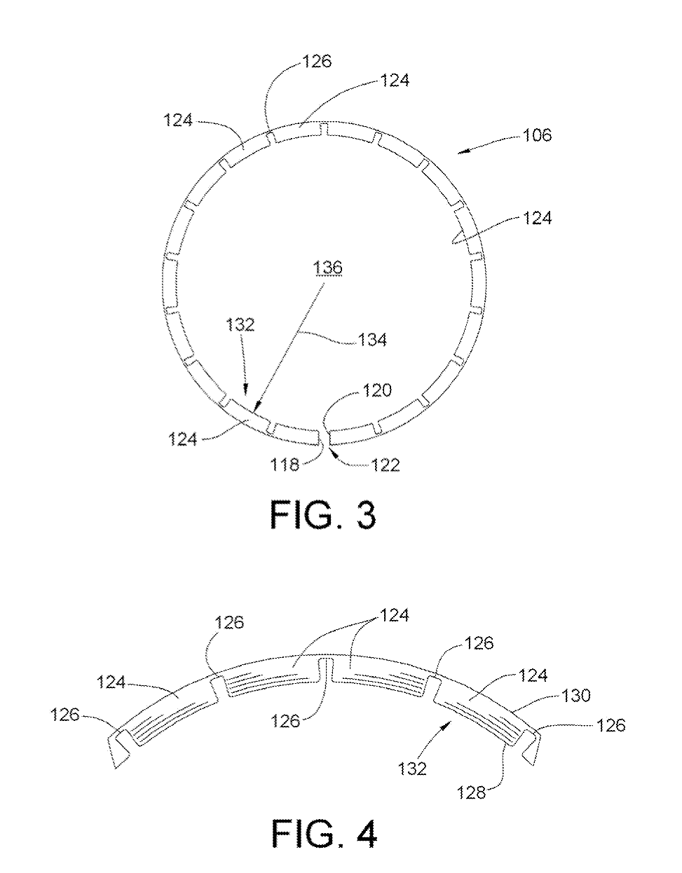

As best seen in FIGS. 3-5, the first exemplary embodiment of the bearing insert 106 has a unitary body 110 of an appropriate polymer material, defining a longitudinal axis 112 of the insert 106, first and second axially spaced ends 114, 116, of the insert 106, and first and second longitudinal edges 118, 120 of the insert 106 which extend substantially parallel to the longitudinal axis 112 of the insert 106, to thereby form a longitudinally extending slot 122 in the insert 106.

As best seen in FIGS. 3 and 4, the body 110 of the insert 106 further defines a plurality of longitudinally extending bearing segments 124, joined to one another by flexible webs 126.

The bearing segments 124 each define radially inner and radially outer surfaces 128, 130 thereof. The radially inner surface 128 of each of the bearing segments 124 has a longitudinally extending radiused recess 132 therein, with each of the radiused recesses 132 having a radius 134 substantially matching the radius of the shaft, and configured for bearing against a portion of the circumference of the shaft.

The radially outer surfaces 130 of each of the bearing segments 124, is formed in such a manner that, when the insert 106 is disposed within the cylindrical opening 104 in the bearing housing 102, the radially inner surfaces 128 of the bearing segments 124, in combination with one another, substantially define a circumferentially interrupted bore 136, having an internal radius 134 substantially matching the radius of the shaft, and such that the longitudinal edges 118, 120 of the insert 106 form the longitudinally extending slot 122 therebetween.

In FIGS. 3-5, the bearing insert 106 is depicted in a form of the invention wherein the bearing insert 106 is configured to substantially assume a cylindrical form in a free-standing state, even when the insert 106 is not inserted into the cylindrical opening 104 in the bearing housing 102. In preferred embodiments of the invention, it may be desirable to configure the bearing insert 106 in such a manner that the radially outer surfaces of the bearing segments 124 collectively define a surface having a periphery slightly larger than the circumference of the cylindrical opening 104 in the bearing housing 102, so that the bearing insert 106 will exhibit a slight snap-fit tendency when inserted into the cylindrical opening 104.

In some embodiments of the invention, the insert 106 may be configured to substantially assume a non-cylindrical form in a free-standing state, when not inserted into the cylindrical opening 104 in the bearing housing 102. Such a non-cylindrical shape may be more advantageously formed, or provide a greater snap-fit force for retaining the insert 106 within the housing 102.

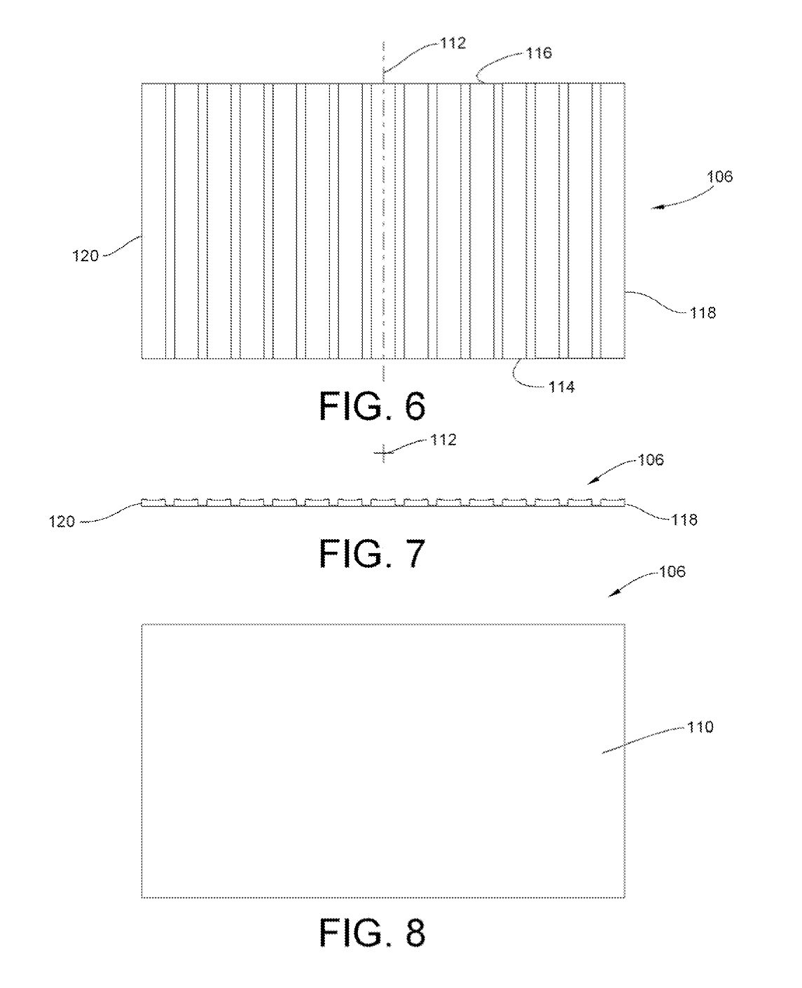

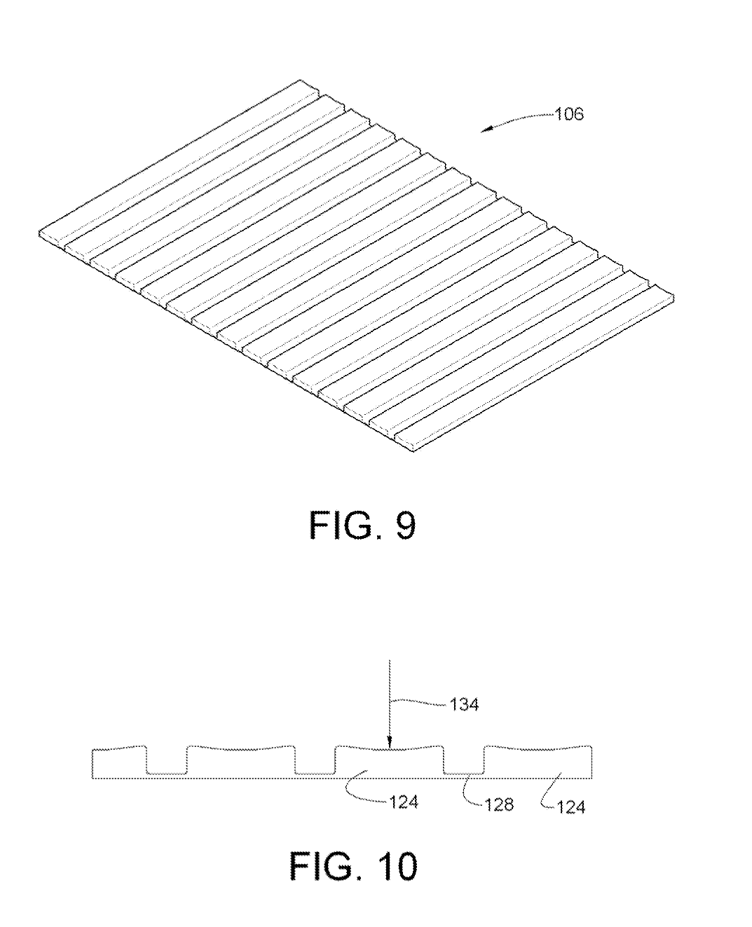

With particular regard to ease of manufacturing, and to provide a substantial advantage in the form of a reduction in the space required for handling inventory, in addition to providing a form which is more readily shippable, as a spare part, for example, FIGS. 6-10 illustrate an alternate embodiment of the insert 106, in which the insert 106 substantially assumes a flat, planar form, in a free-standing state. It will be understood, by those having skill in the art, that the alternate embodiment of the insert 106 shown in FIGS. 6-10 is substantially identical to the insert 106 described above in relation to FIGS. 3-5, except for the fact that the insert of FIGS. 3-5 assumes a substantially cylindrical shape, while free-standing, whereas the embodiment shown in FIGS. 6-10 assumes a substantially flat, planar shape in a free-standing state. To facilitate understanding of the embodiment illustrated in FIGS. 6-10, identical reference numerals, to those utilized in FIGS. 3-5, are applied to salient features of the embodiment shown in FIGS. 6-10.

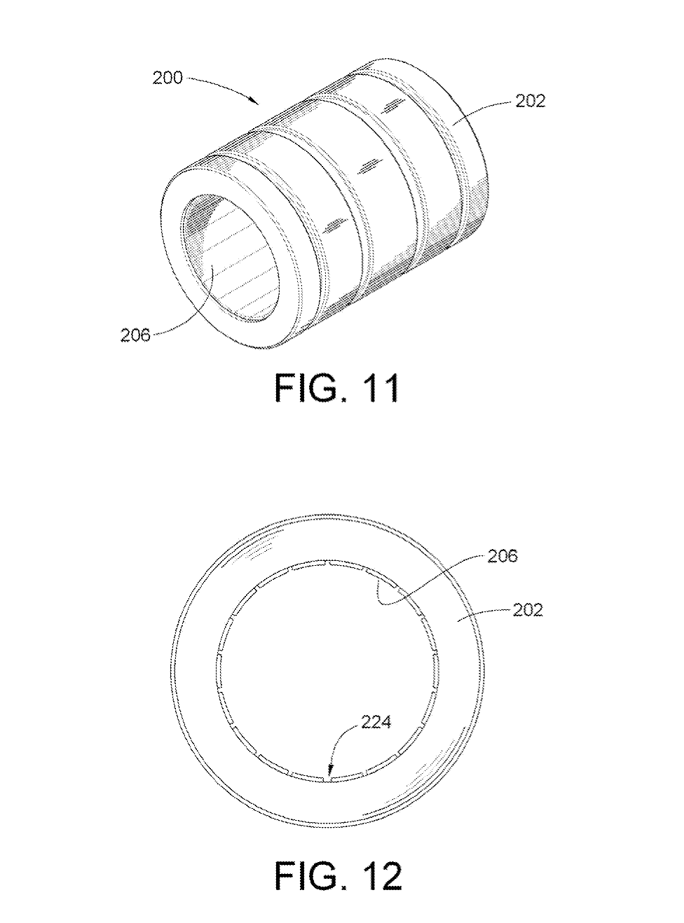

Prior to inserting the embodiment of the insert 106 shown in FIGS. 6-10 into the cylindrical opening 104, the insert 106 is rolled about its longitudinal axis 112, as indicated in FIGS. 11 and 12, into a form small enough to fit into the cylindrical opening 104 in the bearing housing 102. Once the rolled bearing insert 106 is inserted into the opening 104, it is released and allowed to expand toward its free-standing state within the cylindrical opening 104. As the insert 106 expands toward its free-standing state, it will be constrained by the cylindrical opening 104 to assume a cylindrical shape, substantially identical to the form of the insert shown in FIGS. 3-5.

The first exemplary embodiment of the bearing apparatus 100, according to the invention, also includes an adhesive (not shown) disposed between the bearing insert 106 and the housing 102, for attaching the bearing insert 106 to the housing 102 for retaining the bearing insert 106 within the cylindrical opening 104 in the bearing housing 102.

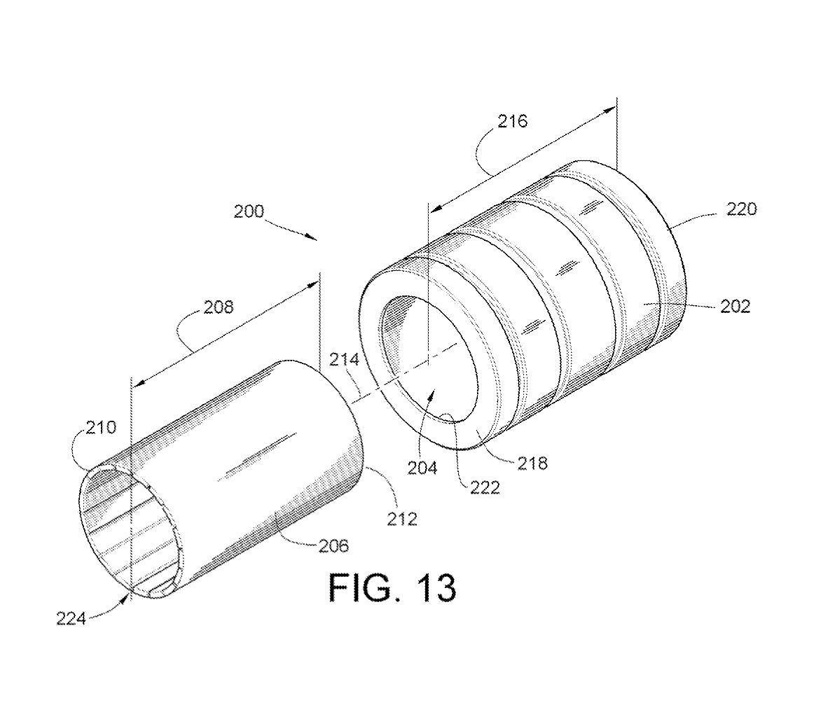

FIGS. 11-13 show a second exemplary embodiment of a bearing apparatus 200, according to the invention, which incorporates an alternative approach to retaining the extrudable bearing insert 206 within the cylindrical opening 204 in the bearing housing 202. As best seen in FIG. 13, the second exemplary embodiment of the extrudable bearing insert 206 defines a longitudinal length 208 thereof, extending between first and second axial ends 210, 212 of the bearing insert 206, along a longitudinal axis 214. The second exemplary embodiment of the bearing housing 202 has a longitudinal length 216 greater than the longitudinal length 208 of the bearing insert and extending between first and second axial ends 218, 220 of the bearing housing 202.

The bearing housing 202 further includes a pair of insert retaining features, in the form of a pair of annular flanges 222 (only one of which is visible in FIG. 13) extending substantially radially into the cylindrical opening 204 in the bearing housing 202, for engaging the axial ends 210, 214 of the bearing insert 206, to thereby preclude axial movement of the insert 206 within the bearing housing 202, when the bearing insert 206 is disposed within the cylindrical bore 204 of the bearing housing 202.

The bearing insert 206 is configured to include a longitudinally extending slot 224 therein, in the same manner as described above with regard to the slot 122 in the first exemplary embodiment of the extrudable bearing insert 106. To insert the bearing insert 206 into the cylindrical opening 204 in the bearing housing 202 of the second exemplary embodiment 200 of the invention, the edges of the longitudinally extending slot 224 in the bearing insert 206 are radially offset slightly from one another, and the bearing is constricted slightly about the longitudinal axis 214, so that the bearing insert 206 may slide past the annular flange 222 at one end of the bearing housing 202 and into the interior of the bearing housing 202. Once inside the bearing housing 202, the bearing insert 206 is released and expands outward into contact with the interior wall of the housing 202 defining the cylindrical opening 204.

In embodiments of the invention subjected primarily to axial motion of the shaft through the bearing insert, the bearing insert 206 may not need to be further attached to the bearing housing 202. The annular flanges 222 at the ends of the cylindrical opening 204, will bear against the ends 210, 212 of the bearing insert 206, to thereby preclude axial movement of the bearing insert 206 out of the housing 202.

Alternatively, in other embodiments of the invention, and in particular where it is desirable to preclude radial movement of the bearing insert 206 inside of the housing 202, the bearing apparatus 200 may further include an adhesive disposed between the bearing insert 206 and the housing 202.

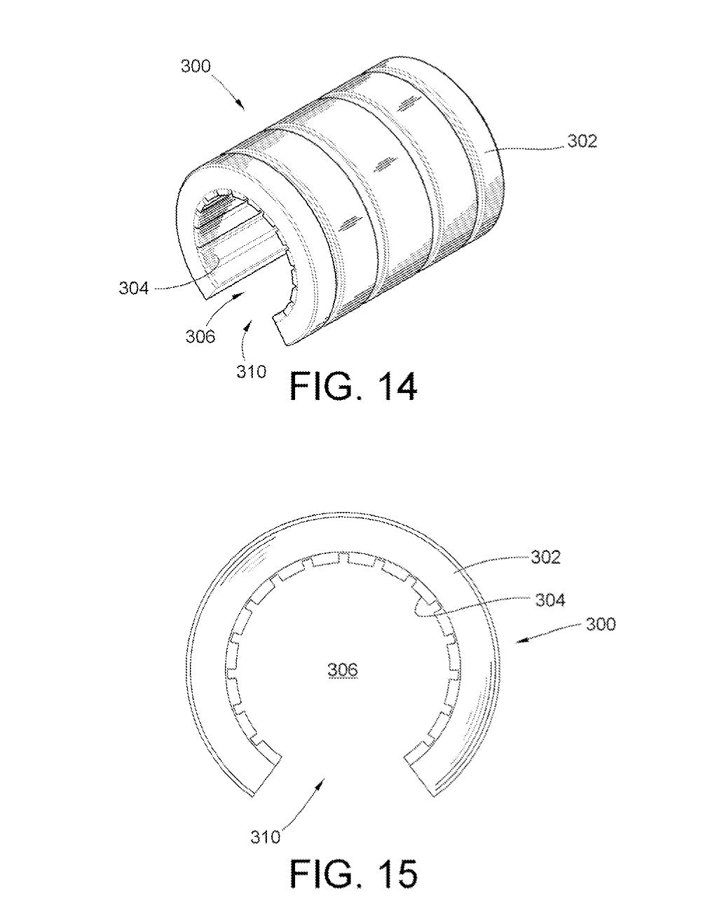

FIGS. 14 and 15, illustrate a third exemplary embodiment of a bearing apparatus 300, according to the invention, having a bearing housing 302 and a bearing insert 304, adapted for insertion into a substantially cylindrically shaped opening 306, within the housing 302.

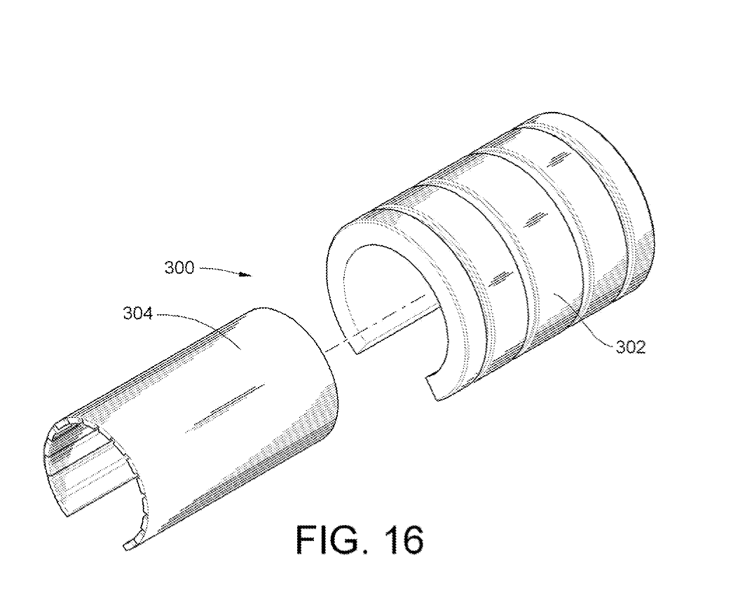

From a comparison of FIGS. 14 and 15 to FIGS. 1, 2 and 5, it will be apparent, to those having skill in the art, that the embodiment shown in FIGS. 1, 2 and 5 illustrates a closed cylindrical bearing apparatus, whereas the embodiment shown in FIGS. 15 and 16 illustrates an open bearing arrangement. It will be further understood, that the construction of the insert 304 and its interconnection with the housing 302, in the third embodiment of the invention, are substantially identical to the construction and connection described above with regard to the first exemplary embodiment of the invention shown in FIGS. 1-5.

Close inspection of the insert 304 of the second embodiment, as shown in FIG. 15, will reveal that two of the bearing segments, on either side of the longitudinally extending gap 122 of the first exemplary embodiment of the insert 104 have been removed, to form a wider longitudinally extending gap 310 which is oriented to correspond with an opening 312 in the bearing housing 302, of the third exemplary embodiment 300 of the invention.

Those having skill in the art will recognize, therefore, that the second exemplary embodiment of the insert 304 may be alternatively formed, in various embodiments, either as shown in FIG. 15, in a flat planar, cylindrical or non-cylindrical form, or may alternatively be fabricated by cutting away a portion of the first exemplary embodiment of an insert 106, according to the invention. Having such optional methods for producing the second exemplary embodiment of the insert 304 provides significant advantages in manufacturing flexibility and reductions in required inventory, to provide inserts for both closed and open bearing arrangements, according to the invention.

The third exemplary embodiment of the bearing apparatus 300, according to the invention, may also include an adhesive (not shown), disposed between the bearing insert 304 and the bearing housing 302, for attaching the bearing insert to the interior wall of the housing 302 defining the cylindrical opening 306. Alternatively, the third exemplary embodiment of the invention may incorporate annular flanges (not shown) at opposite ends of the cylindrical opening 306, similar to those flanges 222 described above in relation to the second exemplary embodiment 200 of the invention, for axially retaining the bearing insert 304, in combination with the adhesive (not shown) disposed between the bearing insert 304 and the bearing housing 302.

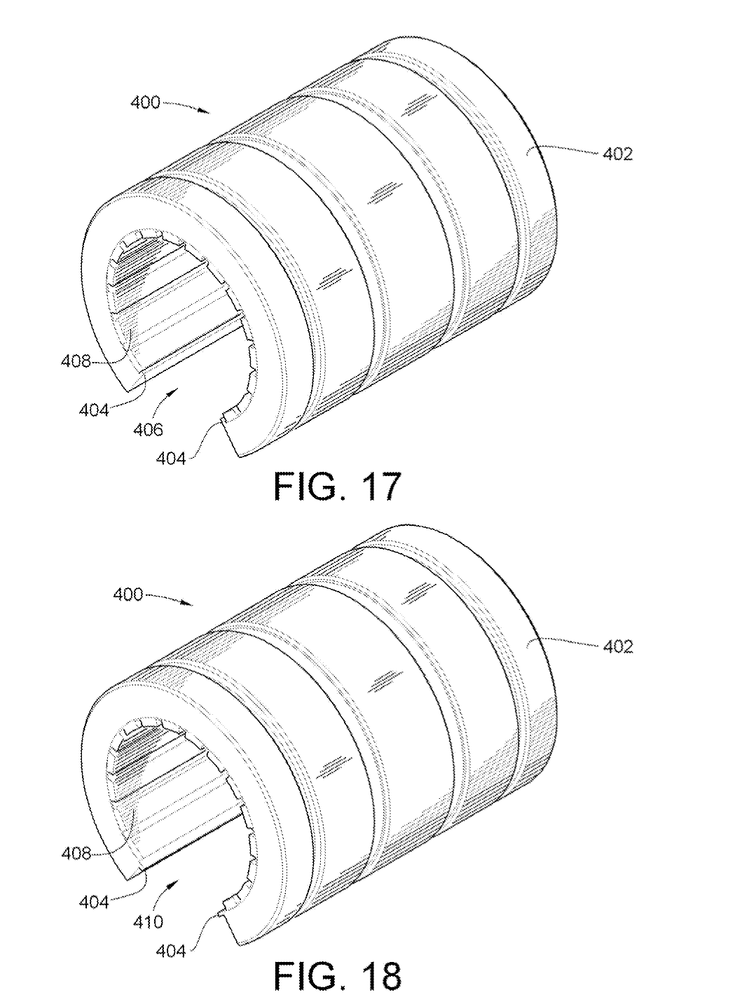

FIGS. 16 and 17 show a fourth exemplary embodiment 400 of the invention, which is substantially identical to the third exemplary embodiment 300 described above, with the exception that the housing 402 of the fourth exemplary embodiment of the invention 400 includes a pair of longitudinally extending ribs 404, positioned adjacent a longitudinally extending slot 406 of the housing 402, and configured to bear against the longitudinally extending edges of the bearing insert 408, for precluding radial rotation of the bearing insert 408 with respect to the housing 402. It is further noted, that the fourth exemplary embodiment of the invention 400 might also include annular flanges (not shown) at opposite ends of the cylindrical opening 410, in combination with the longitudinally extending ribs 404, to provide mechanical retention both axially and radially of the bearing insert 408 within the bearing housing 402.

As illustrated in FIG. 17, the longitudinally extending ribs 404 may be provided in an initially uncrimped orientation, as shown in FIG. 17, and then formed into place against the longitudinally extending edges of the bearing insert 408, to a crimped position thereof, as shown in FIG. 16. Forming of the longitudinally extending ribs from the uncrimped to the crimped positions thereof, may be carried out in such a manner that the longitudinally extending ribs 404 grip or bite into the bearing insert 408 securely enough that both axial and radial movement of the bearing insert 408 are precluded, even in embodiments of the invention which do not also include annular flanges at the end of the cylindrical opening 410.

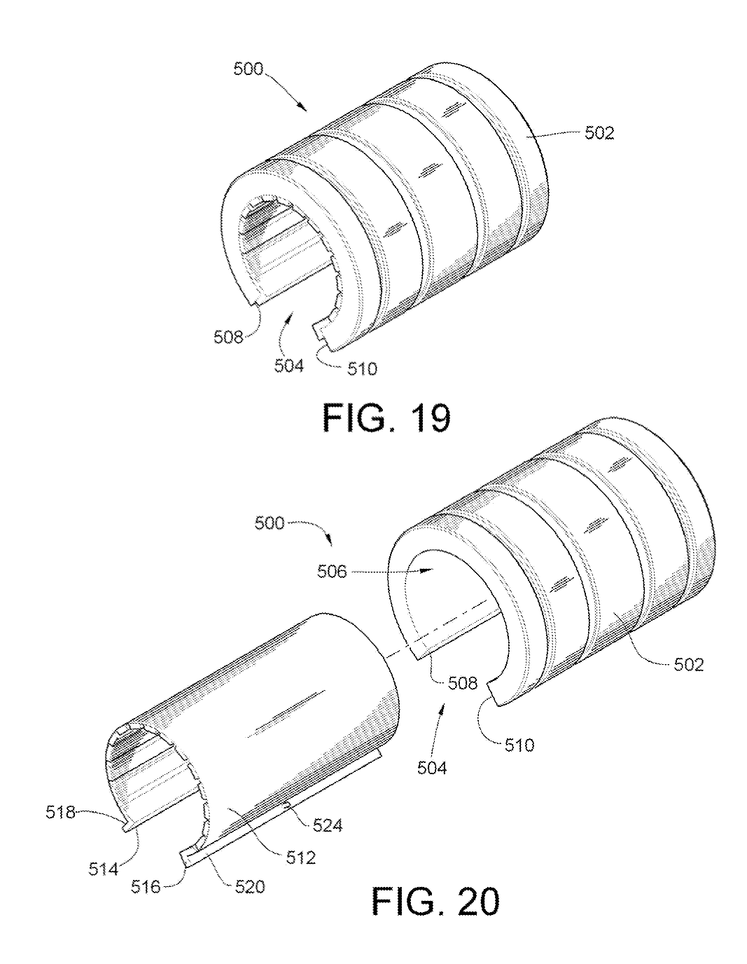

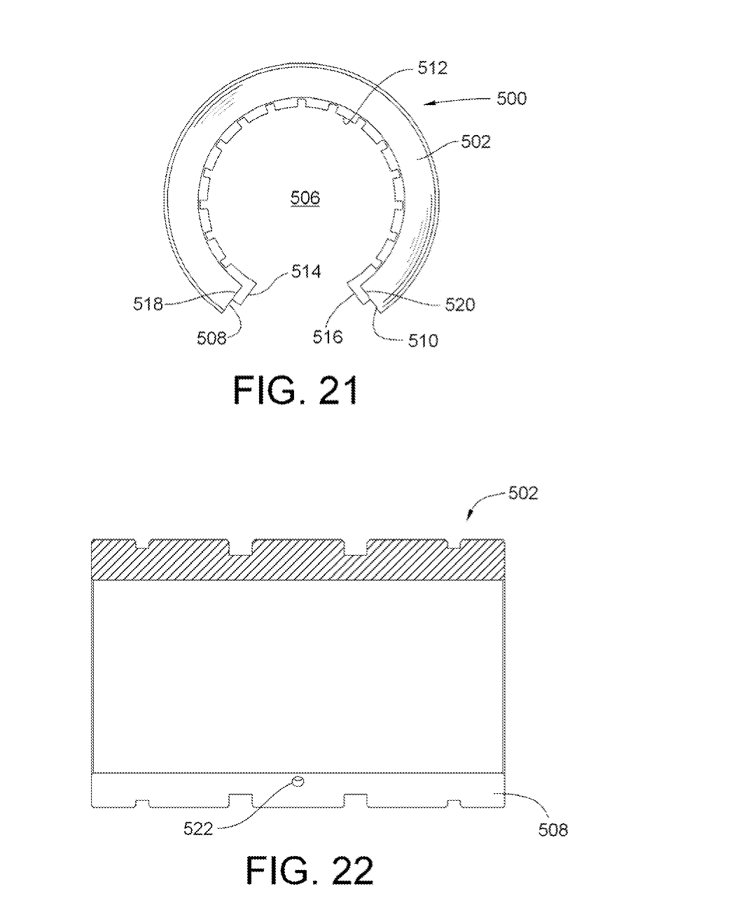

FIGS. 19-24 show a fifth exemplary embodiment of a bearing apparatus 500, according to the invention, which is similar to the open bearing configuration 300, discussed above with regard to FIGS. 14-16. Specifically, in the fifth 33 of the bearing apparatus 500, the bearing housing 502 defines a longitudinally extending slot 504 therein, opening outward from a cylindrical opening 506 in the housing 502, and defining first and second longitudinally extending edges 508, 510 of the slot 504 in the housing 502.

The bearing insert 512, is generally similar to the bearing insert 304, described above in relation to the third exemplary embodiment 300 of the invention, with the exception that the bearing insert 512 of the fifth exemplary embodiment of the invention 500 also includes longitudinally extending first and second locating flanges 514, 516 having backsides 518, 520 thereof, extending outward from the first and second longitudinally extending edges of the insert 512 beyond the outer surface of the bearing segments of the insert 512, with the backsides 518, 520 of the locating flanges 514, 516 adapted for substantially faying contact with the first and second longitudinally extending edges 508, 510 of the slot 504 in the bearing housing 502, in the manner best illustrated in FIGS. 19, 21 and 24.

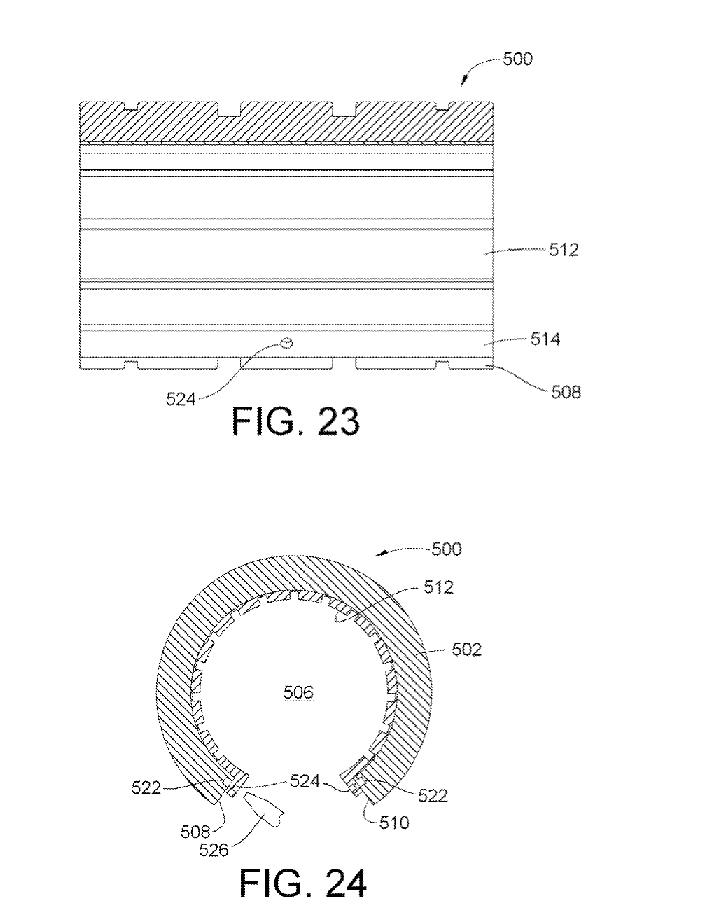

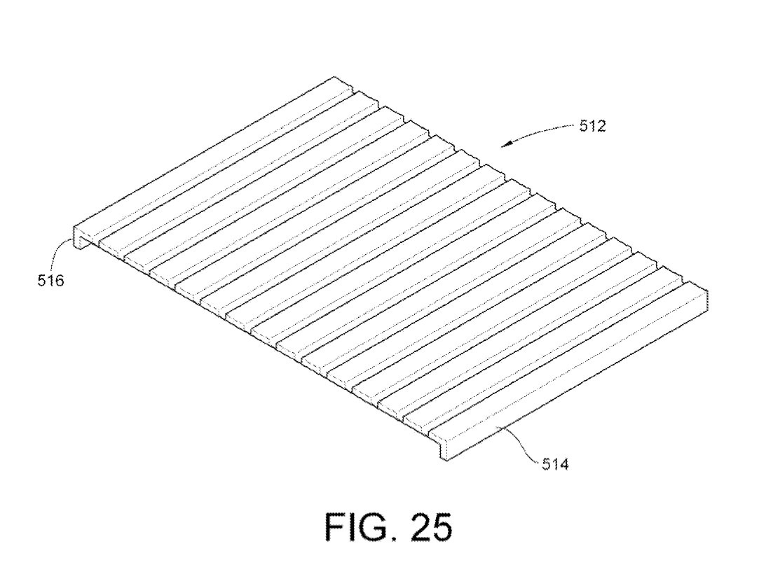

As shown in FIG. 22, the first and second longitudinally extending edges 508, 510 of the slot 504 in the housing 502 each include one or more depressions 522, which are configured to received corresponding deformations 524, as shown in FIGS. 23 and 24, which engage the depressions 522 on the longitudinally extending edges 508, 510 of the slot 504 in the bearing housing 502, to thereby provide both axial and radial retention of the bearing insert 512 within the bearing housing 502.

As indicated in FIG. 24, the depressions 522 may be formed in the locating flanges 514, 516 of the bearing insert 512 by application of ultrasonic energy from a transducer 526, or by another appropriate method, after the bearing insert 512 has been inserted into the cylindrical opening 506 in the bearing housing 502.

As will be understood, from an examination of FIGS. 20 and 25, the bearing insert 512 of the fifth exemplary embodiment of the invention may be alternatively formed in a number of free-standing shapes, such as the substantially cylindrical form shown in FIG. 20, or a variety of non-cylindrical forms, including a substantially flat, planar form, as illustrated in FIG. 25.

In forms of the invention including locating flanges, such as the flanges 514, 516 of the fifth exemplary embodiment 500 of the invention, it will be further understood that various combinations of features described hereinabove, when utilizes separately or in various combinations thereof, for retaining the insert 512 within the housing 502. For example, the bearing insert 512 may be secured within the housing 502 by use of an adhesive rather than the engagement of the deformations 524 with the depressions 522. The housing 502 may include annular flanges at opposite ends of the cylindrical opening, in some embodiments of the invention.

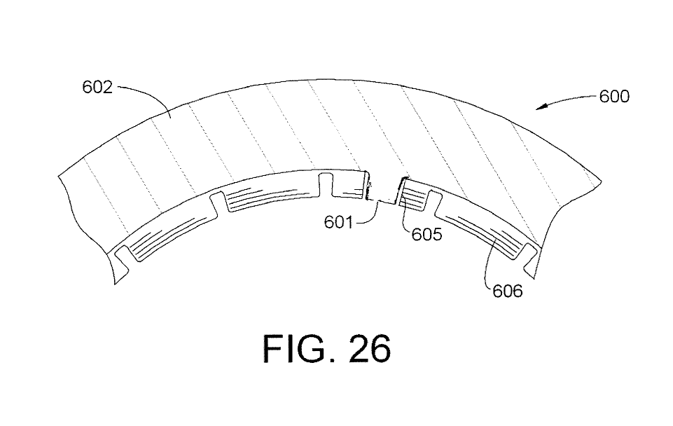

As shown in FIG. 26, in a sixth exemplary embodiment of a bearing apparatus 600, according to the invention, the bearing housing 602 includes an insert retaining element 601 extending inward from the inside wall of the housing 602 into the cylindrical opening 604 of the housing 602. The retaining element 601 is configured for engagement with a cooperatively formed depression 605 formed in an extrudable bearing insert 606, in a manner precluding both axial and radial movement of the bearing insert 606 within the bearing housing 602.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An extrudable polymer bearing insert for a sliding bearing, adapted for insertion into a substantially cylindrical longitudinally oriented opening in a bearing housing and for use with a shaft extending longitudinally through the cylindrical opening in the bearing housing wherein the shaft has a radius, an outer diameter, and a corresponding circumference thereof, the bearing insert comprising:
a body of polymer material, defining a longitudinal axis of the insert along which the insert may be net-shape-formed by extrusion;
the body also defining first and second spaced longitudinal edges of the insert extending substantially parallel to the longitudinal axis of the insert;
the body further defining a plurality of longitudinally extending bearing segments joined to one another by flexible webs;
the bearing segments each defining inner and outer substantially longitudinally extending surfaces thereof;
the inner surface of each of the bearing segments having a longitudinally extending radiused recess therein with the radius of the radiused recess substantially matching the radius of the shaft, and formed for bearing against a portion of the circumference of the shaft;
the outer surface of each of the bearing segments being formed in such a manner that, when the insert is disposed within the cylindrical opening in the bearing housing, the inner surfaces of the bearing segments, in combination with one another, substantially define a circumferentially interrupted bore having an internal radius substantially matching the radius of the shaft, and such that the longitudinal edges of the insert form a longitudinally extending opening therebetween.

2. The bearing insert of claim 1, wherein:
each of the bearing segments defines side walls thereof, with one of the side walls of each of a first and a second one of the bearing segments defining the first and second longitudinally extending edges of the insert; and
the bearing insert is further configured to be longitudinally trimmable along a side edge of another one or more bearing segments for forming an insert for an open bearing.

3. The bearing insert of claim 1, wherein, the bearing insert substantially assumes a cylindrical form in a free-standing state, even when not inserted into the cylindrical opening in the bearing housing.

4. The bearing insert of claim 1, wherein, the bearing insert substantially assumes a non-cylindrical form in a free-standing state, when not inserted into the cylindrical opening in the bearing housing.

5. The bearing insert of claim 4, wherein, the bearing insert substantially assumes a flat planar form in a free-standing state, when not inserted into the cylindrical opening in the bearing housing.

6. The bearing insert of claim 1, wherein, the bearing is an open bearing with the bearing housing defining a longitudinally extending slot therein opening outward from the cylindrical opening in the housing and defining first and second longitudinally extending edges of the slot in the housing, and the bearing insert further comprises:
longitudinally extending first and second locating flanges having back sides thereof extending outward from the first and second longitudinally extending edges of the insert beyond the outer surface of the bearing segments, with the back sides of the locating flanges adapted for substantially faying contact with the first and second longitudinally extending edges of the slot in the bearing housing.

7. The bearing insert of claim 6, wherein, the back sides of the locating flanges extend substantially radially outward from the longitudinal axis, when the bearing insert is disposed within the cylindrical opening in the bearing housing with the back sides substantially in faying contact with the edges of the longitudinally extending slot in the housing.

8. The bearing insert of claim 7, wherein, the locating flanges are formed from a material that is amenable to localized deformation when exposed to ultrasonic vibration.

9. The bearing insert of claim 7, wherein, except for the locating flanges, the bearing insert substantially assumes a cylindrical form in a free-standing state, with the locating flanges extending outward from the cylindrical form, even when not inserted into the cylindrical opening in the bearing housing.

10. The bearing insert of claim 1, wherein, except for the locating flanges, the bearing insert substantially assumes a non-cylindrical form in a free-standing state, with the locating flanges extending outward from the otherwise substantially non-cylindrical form, when not inserted into the cylindrical opening in the bearing housing.

11. The bearing insert of claim 10, wherein, except for the locating flanges, the bearing insert substantially assumes a flat planar form in a free-standing state, with the locating flanges extending outward from the otherwise substantially flat planar form, when not inserted into the cylindrical opening in the bearing housing.

12. A method for forming an extrudable polymer bearing insert for a sliding bearing, adapted for insertion into a substantially cylindrical longitudinally oriented opening in a bearing housing and for use with a shaft extending longitudinally through the cylindrical opening in the bearing housing wherein the shaft has a radius, an outer diameter, and a corresponding circumference thereof, the method comprising, forming a bearing insert having:
a body of polymer material, defining a longitudinal axis of the insert along which the insert may be net-shape-formed by extrusion;
the body also defining first and second spaced longitudinal edges of the insert extending substantially parallel to the longitudinal axis of the insert;
the body further defining a plurality of longitudinally extending bearing segments joined to one another by flexible webs;
the bearing segments each defining inner and outer substantially longitudinally extending surfaces thereof;
the inner surface of each of the bearing segments having a longitudinally extending radiused recess therein with the radius of the radiused recess substantially matching the radius of the shaft, and formed for bearing against a portion of the circumference of the shaft;
the outer surface of each of the bearing segments being formed in such a manner that, when the insert is disposed within the cylindrical opening in the bearing housing, the inner surfaces of the bearing segments, in combination with one another, substantially define a circumferentially interrupted bore having an internal radius substantially matching the radius of the shaft, and such that the longitudinal edges of the insert form a longitudinally extending opening therebetween.

13. The method of claim 12, further comprising, forming the bearing insert by extruding the bearing insert along the longitudinal axis.

14. The method of claim 13, further comprising, extruding a body having an initial axial length greater than a desired axial length of the bearing insert and cutting the body to the desired axial length of the bearing insert.

15. The method of claim 13, further comprising, forming the bearing insert such that:
each of the bearing segments defines side walls thereof, with one of the side walls of each of a first and a second one of the bearing segments defining the first and second longitudinally extending edges of the insert; and
the bearing insert is further configured to be longitudinally trimmable along a side edge of another one or more bearing segments for forming an insert for an open bearing.

16. The method of claim 15, further comprising, longitudinally trimming the bearing insert along a side edge of the another one of the another one or more bearing inserts.

17. The method of claim 12, wherein, further comprising, forming the bearing insert in such a manner that the bearing insert substantially assumes a flat planar form in a free-standing state, when not inserted into the cylindrical opening in the bearing housing.

18. A bearing apparatus comprising:
a bearing housing having a cylindrical opening extending substantially longitudinally therethrough; and
an extrudable bearing insert adapted for insertion into the substantially cylindrical longitudinally oriented opening in the bearing housing and for use with a shaft extending longitudinally through the cylindrical opening in the bearing housing, with the shaft having a radius, an outer diameter, and a corresponding circumference thereof;
the bearing insert having a unitary body of polymer material, defining a longitudinal axis of the insert along which the insert may be net-shape-formed by extrusion;
the body also defining first and second spaced longitudinal edges of the insert extending substantially parallel to the longitudinal axis of the insert;
the body further defining a plurality of longitudinally extending bearing segments joined to one another by flexible webs;
the bearing segments each defining inner and outer substantially longitudinally extending surfaces thereof;
the inner surface of each of the bearing segments having a longitudinally extending radiused recess therein with the radius of the radiused recess substantially matching the radius of the shaft, and formed for bearing against a portion of the circumference of the shaft;
the outer surface of each of the bearing segments being formed in such a manner that, when the insert is disposed within the cylindrical opening in the bearing housing, the inner surfaces of the bearing segments, in combination with one another, substantially define a circumferentially interrupted bore having an internal radius substantially matching the radius of the shaft, and such that the longitudinal edges of the insert form a longitudinally extending opening therebetween.

19. The bearing apparatus of claim 18, further comprising, an adhesive disposed between the bearing insert and the housing, for attaching the bearing insert to the housing, to thereby retain the bearing insert within the cylindrical opening in the bearing housing.

20. The bearing apparatus of claim 18, wherein:
the bearing insert further defines a longitudinal length thereof extending between first and second axial ends of the bearing insert;
the bearing housing has a longitudinal length greater than the longitudinal length of the bearing insert, extending between first and second axial ends of the bearing housing; and
the bearing housing further includes at least one insert retaining feature extending substantially radially into the cylindrical opening in the bearing housing for engaging one of the axial ends of the bearing insert, to thereby preclude axial movement of the insert with respect to the bearing housing when the bearing insert is disposed within the cylindrical bore.

21. The bearing apparatus of claim 20, wherein, the insert retaining feature comprises, an annular flange disposed within the cylindrical opening in the bearing housing, adjacent one of the axial ends of the bearing housing.

22. The bearing apparatus of claim 21, wherein, the bearing housing further comprises, annular flanges disposed within the cylindrical opening in the bearing housing, adjacent both axial ends of the bearing housing.

23. The bearing apparatus of claim 22, wherein:
the bearing is an open bearing with the bearing housing further defining a longitudinally extending slot therein opening outward from the cylindrical opening in the housing and defining first and second longitudinally extending edges of the slot in the housing; and
the bearing insert further comprises, longitudinally extending first and second locating flanges having back sides thereof extending outward from the first and second longitudinally extending edges of the insert beyond the outer surface of the bearing segments, with the back sides of the locating flanges adapted for substantially faying contact with the first and second longitudinally extending edges of the slot in the bearing housing.

24. The bearing apparatus of claim 23, wherein:
the first and second longitudinally extending edges of the of the housing each include one or more depressions therein; and
the locating flanges include corresponding deformations therein engaging the depressions on the longitudinally extending edges of the slot in the bearing housing.

25. The bearing apparatus of claim 18, wherein:
the bearing is an open bearing with the bearing housing further defining a longitudinally extending slot therein opening outward from the cylindrical opening in the housing and defining first and second longitudinally extending edges of the slot in the housing; and
the bearing insert further comprises, longitudinally extending first and second locating flanges having back sides thereof extending outward from the first and second longitudinally extending edges of the insert beyond the outer surface of the bearing segments, with the back sides of the locating flanges adapted for substantially faying contact with the first and second longitudinally extending edges of the slot in the bearing housing.

26. The bearing apparatus of claim 18, wherein:
the first and second longitudinally extending edges of the of the housing each include one or more depressions therein; and
the locating flanges include corresponding deformations therein engaging the depressions on the longitudinally extending edges of the slot in the bearing housing.

27. The bearing apparatus of claim 18, wherein, the bearing housing further comprises at least one insert retaining feature extending substantially radially into the cylindrical opening in the bearing housing for engaging the bearing insert, to thereby preclude movement of the insert with respect to the bearing housing when the bearing insert is disposed within the cylindrical bore.

28. The bearing apparatus of claim 27, wherein, the bearing insert further comprises a retaining recess therein, cooperatively configured for operatively engaging the insert retaining feature extending from the housing.

29. The bearing apparatus of claim 18, wherein:
the bearing is an open bearing with the bearing housing further defining a longitudinally extending slot therein opening outward from the cylindrical opening in the housing and defining first and second longitudinally extending edges of the slot in the housing;
the bearing housing further comprises one or more insert retaining features extending substantially radially into the cylindrical opening in the bearing housing for engaging the bearing insert, to thereby preclude movement of the insert with respect to the bearing housing when the bearing insert is disposed within the cylindrical bore.

30. The bearing apparatus of claim 29, wherein, the insert retaining features comprise inwardly extending retaining elements disposed adjacent the first and second edges of the longitudinally extending slot in the bearing housing, and adapted for operatively engaging the first and second longitudinal edges of the bearing insert, to thereby preclude radial movement of the insert within the cylindrical opening in the housing.

31. The bearing apparatus of claim 30, wherein, the inwardly extending retaining elements disposed adjacent the first and second edges of the longitudinally extending slot in the bearing housing comprise, longitudinally extending flanges.

32. The bearing apparatus of claim 31, wherein:
the bearing insert further defines a longitudinal length thereof extending between first and second axial ends of the bearing insert;
the bearing housing has a longitudinal length greater than the longitudinal length of the bearing insert extending between first and second axial ends of the bearing housing; and
the bearing housing further includes at least one insert retaining feature extending substantially radially into the cylindrical opening in the bearing housing for engaging one of the axial ends of the bearing insert, to thereby preclude axial movement of the insert with respect to the bearing housing when the bearing insert is disposed within the cylindrical bore.

33. The bearing apparatus of claim 32, wherein, the insert retaining feature comprises, an annular flange disposed within the cylindrical opening in the bearing housing, adjacent one of the axial ends of the bearing housing.

34. The bearing apparatus of claim 33, wherein, the bearing housing further comprises, annular flanges disposed within the cylindrical opening in the bearing housing, adjacent both axial ends of the bearing housing.
